(19) United States
(12) Patent Application Publication
(10) Pub. No.: US 2018/0255963 A1
(43) Pub. Date: Sep. 13, 2018

(54) KIT FOR CAPSULE COFFEE MACHINES AND METHODS OF USE THEREOF

(71) Applicant: Mokitalia S.r.l., Milano (IT)

(72) Inventor: Marco Colombo, Biassono (MB) (IT)

(73) Assignee: Mokitalia S.r.l., Milano (IT)

(21) Appl. No.: 15/700,460

(22) Filed: Sep. 11, 2017

(30) Foreign Application Priority Data
Mar. 9, 2017 (SM) SM/P/2017/00148

(51) Int. Cl. A47J 31/60; B08B 3/08; B08B 3/10; C11D 17/04

(52) U.S. Cl. CPC A47J 31/60; B08B 3/08; A47J 31/407; C11D 17/042; B08B 3/106

(57) ABSTRACT

A KIT for a capsule machine, in particular for a coffee capsule machine comprising, in cascade, a feeding water reservoir (14), an infusion model (12) and a brewing group (16) and set up to prepare brews with hot water under pressure. The KIT comprises at least a soluble product set up to be inserted in a body of a capsule (22), at least a cap comprising on a crown or edge thereof an adhesive set up to seal the soluble product inside the body of the capsule (22), so as to, during use, the capsule (22) obtained with the KIT (30) can be inserted in the infusion module (12) of the machine (10) to carry out a cleaning an hygiene operation of the brewing group (16) during at least an empty cycle of said machine (10). The invention also relates to a method for arranging and using cleaning and hygiene KIT of a capsule machine.

This U.S. Non-Provisional application claims priority to and the benefit from Sammarinese Patent Application No. SMP-201700148 filed on Mar. 9, 2017, the content of which is incorporated herein by reference in its entirety.

### DESCRIPTION

### Technical Field

The present invention relates, in general, to a KIT to be used on coffee capsule machines.

In particular, the present invention relates to a KIT arranged to be used by users of coffee capsule machines after a predetermined number of cycles of coffee preparation or other products for brews arranged in capsules.

### Background Art

Coffee capsule machines are known.

Such machines comprise, in general, an infusion module comprising an infusion chamber in which it is envisaged that a single capsule is inserted for the preparation of a coffee or another kind of brew.

The infusion chamber is connected, in general through feeding ducts to a water reservoir from which water is pumped and introduced heated and under pressure inside the infusion chamber to obtain the brew.

The capsules for such machines have, in general a truncated conic shape comprise, inside, the product for brews and are sealed through a cap that, during use, is perforated so as to the water under pressure, coming from the reservoir, produces the brew.

The brew is granted in a cup outside the machine through a set of granted ducts envisaged, for example, in a brewing group connected in exit to the infusion chamber of the infusion module. Anti-limestone products envisaged to reduce or avoid limestone deposits which normally forms in they feeding ducts cause of the fact that they are gone across by hot water under pressure.

Such anti-limestone products are inserted in the water reservoir of the machine so as to, during empty cycles of the machine itself, allow the anti-limestone products to reduce or avoid the limestone deposits present in the feeding ducts.

A problem of the capsule machines is that, during their use, the products for brews or also parts of the cap accumulate in the ducts causing both the formation of bacterium colonies and possible occlusions or stoppages of the same supply ducts.

The known solution to such problems envisages that a technician intervenes through disassembly, cleaning and replacement of the infusion module and/or of the brewing group.

In the prior art there are no solutions to solve in an easy and efficacious manner the problem of both avoiding the formation of the bacterium colonies and possible occlusions or stoppages of the infusion module and/or the brewing group of a capsule machine.

### DESCRIPTION OF THE INVENTION

The aim of the present invention is to solve the technical problems disclosed above.

According to the present invention, this scope is achieved through a KIT for capsule coffee machines having the features described below.

The present invention also relates to a method for arranging and using the KIT.

The following brief description of the invention is provided with the aim of allowing the comprehension of the embodiments of the invention.

According to a feature of a preferred embodiment of the invention the KIT comprises at least a soluble product arranged to be inserted in a body of a capsule and at least a cap comprising, on a crown or edge thereof, an adhesive sets up to seal the soluble product inside the body of the capsule and allow a cleaning and hygiene operation of the brewing group of the capsule machine during at least an empty cycle of the machine.

According to a further embodiment of the of the present invention, the soluble product comprises one or more tablets which slow releases/release oxidizing substances after the contact with hot water under pressure.

### BRIEF DESCRIPTION OF THE DRAWINGS

These and other embodiments and advantages of the present invention will become clear from the following description of a preferred embodiment made as a non-limiting example of the present invention with the help of the enclosed figures, wherein elements shown with the same or with a similar reference number indicate elements having the same or a similar functionality and construction and wherein:

FIG. 1 is a perspective view of a capsule machine;

FIG. 2A shows an embodiment of a cleaning and hygiene kit for the capsule machine of FIG. 1

FIG. 2B shows an embodiment of a pack or box containing the kit of the present invention; and

FIG. 3 is a capsule arranged for the cleaning and hygiene of the machine of FIG. 1.

### DESCRIPTION OF A PREFERRED EMBODIMENT

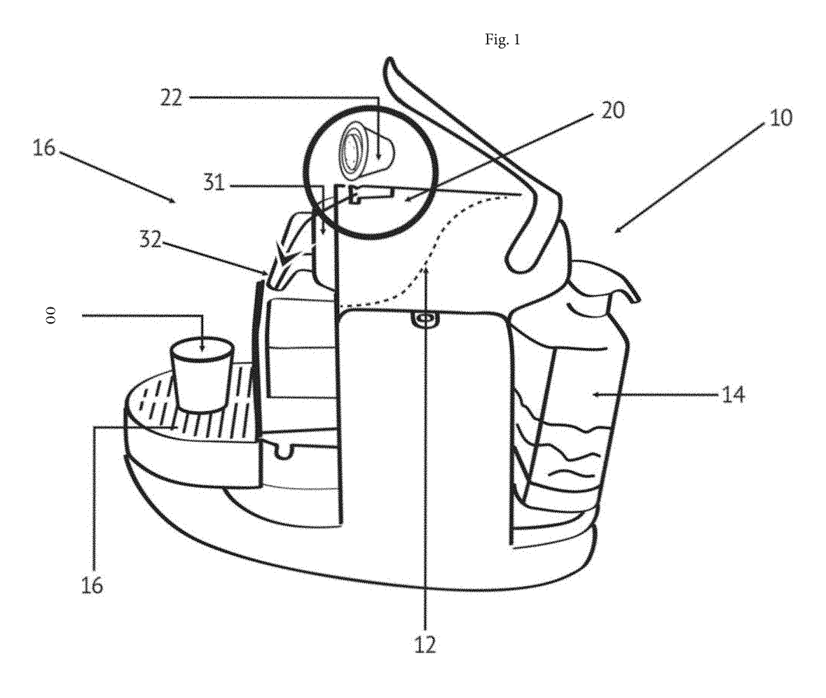

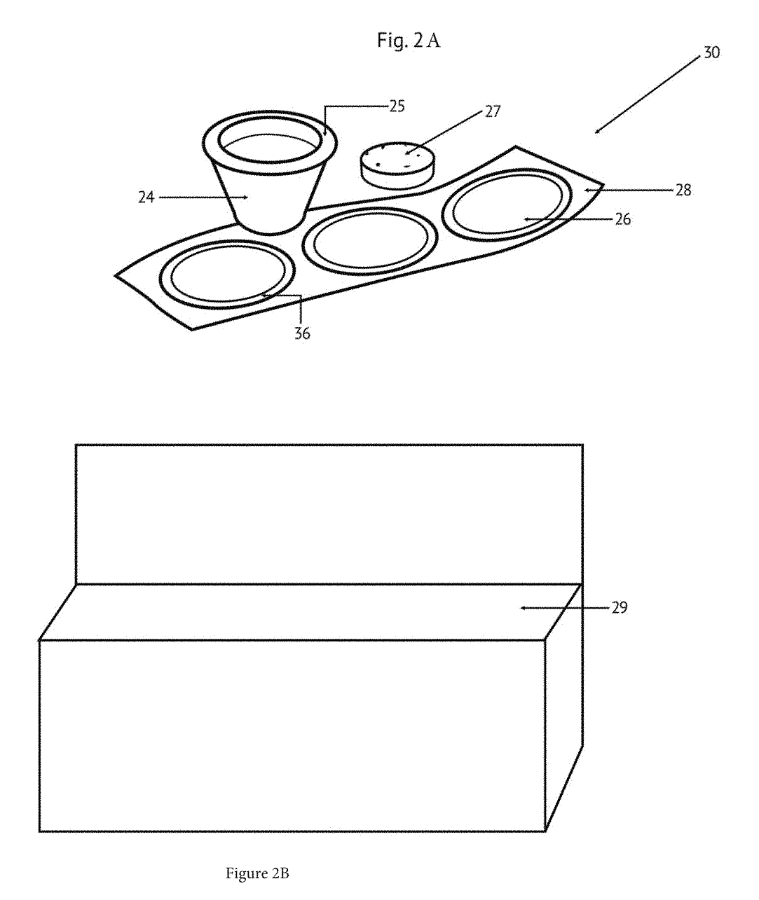

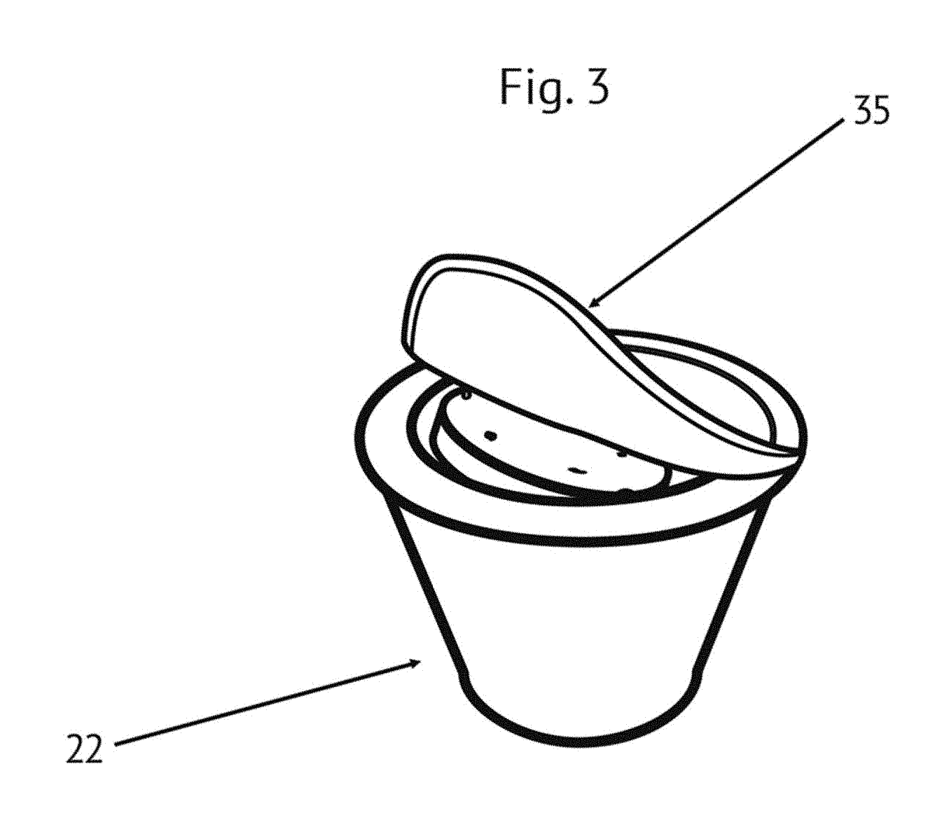

With reference to FIG. 1, a coffee capsule machine (hereinafter capsule machine) 10 comprises an infusion module 12 comprising an infusion chamber 20, a feeding reservoir (reservoir) 14 arranged to contain water useful to brewing, a brewing group 16 and a countertop on which a cap 18 can be put. Such cup 18 is suitable to contain, during use, for example, a brew after the brewing.

In general the infusion chamber 20 is set up so as to contain a capsule 22 containing inside, for example, a product for which the user wants the brewing, for example coffee powder or a powder of another edible substance.

Generally the capsule 22 comprises a body 24 having, preferably a truncated conic shape and a cap 26, for example made with natural aluminum or another material such as perforated polypropylene, aluminum coupled with polypropylene, etc, all of known kind.

During use, the capsule 22 is inserted in the infusion chamber and, after an activation:
the cap 26 of the capsule 22 is, if the case, perforated;
hot water is inserted under pressure in the infusion chamber 20 so as to prepare a brew,
the brew is supplied through the brewing group 16, comprising one or more exit ducts 31 and an exit 32, in the cup 18.

According to a preferred embodiment it is envisaged that for homogeneous kinds of machine 10 a KIT 30 configured to destroy bacterium colonies and/or occlusions or stoppages of the exit ducts 31 and 32. These bacterial colonies and the occlusions and/or stoppages occur because of the brewing substances and/or also, because of parts of the cap of the capsules 22 and, generally, they occur in an evident manner after a determined numbers of brewing cycles, for example after a number of cycles comprised in the range of 200-500.

Preferably, the KIT (cleaning and hygiene KIT) 30 is provided in a pack or box 29 and comprises one or more bodies 24, one or more caps 26 and one or more set of soluble product 27, for example one or more tablets 27 of soluble product suitable to be inserted in corresponding bodies 24 and herein sealed through the corresponding caps 26.

Preferably the KIT 30 comprises, for example, a set of pieces comprising three bodies 24, three caps 26 and three tablets 27 but, as it can be easily understood, the set can comprise a set of pieces comprising at least one piece for kind or more than three pieces for kind without being out of the scope of the invention disclosed and claimed.

According to a possible variant of the disclosed embodiment the KIT 30 in the PACK/PACKAGE 29 does not comprises the bodies 24 but comprises only one or more caps 26 and one or more tablets 27.

According to such an embodiment it is envisaged that, to avoid the bacterial colonies and/or the occlusions or the stoppages, the bodies 24 deriving from the already carried out brewings are used. According to further variants of the disclosed embodiment, the KIT 30 can comprise one or more anti-limestone products 37 to be used in a known manner in empty cycles of the machine 10 inserting the anti-limestone product 37 in the reservoir 14 of the machine, in particular in the water contained therein.

Each soluble product 27, in the form of sachets containing the soluble product or, preferably, in the form of tablets, comprises oxidizing substances suitable to supply oxygen after the contact with hot water under pressure.

In particular, the soluble product is a product known with the commercial name of Ossigeno Attivo, manufactured for example by the Company C.S.C. Società Cooperativa and comprises substances such as the ones listed in Table 1:

Table 1

Even more in particular the soluble product is preferably comprised in the KIT 30 in the form of tablets 27, for example slow release tablets of the diameter comprised in the range of 14-30 mm, suitable to be inserted, for example in a single manner, in the body 24 of the capsule 22 to carry out at least an empty cycle of the machine 10 and to avoid bacterial colonies and/or occlusions or stoppages from the infusion module 12 and/or from the brewing group 16.

The Applicant has observed that it can be preferred the use of the soluble product in the form of tablets since the tablets, being pressed, slowly dissolve and therefore ensure, generally, a slow solubility with the advantage of the sure cleaning and/or hygiene of the brewing group.

In any case also the soluble product in powder can be used without be out of the scope of the invention herein disclosed and claimed.

The method of use of the KIT 30 herein disclosed is the following.

In an initial phase the cleaning and hygiene KIT 30 is arranged by inserting in the PACKAGE 29 at least a set of the soluble product 27, for example a set of tablets 27, at least a set of caps 26 and, if the case, a set of bodies 24.

After a predetermined number of infusion cycles it is envisaged that the user performs the operations of:
inserting the soluble product 27, preferably a tablet 27, in the body 24,
removing the cap 26 from the support material 28,
fixing the cap 26 to the body 24 through the adhesive 35
activating at least an empty cycle of the machine 10 so as to carry out a cleaning and hygiene operation of the brewing group 16 of the machine 10.

Advantageously, the soluble product 27, preferably a product which slow releases oxidizing substances, is suitable for removing residues of infusion products, for example coffee and also cap residues, for example aluminum residues from the infusion module 12 and/or from the brewing group 16.

Advantageously, the soluble product 27 acts on parts that are crossed by the brewed products and it does not act on parts crossed by the sole hot water under pressure.

This fact is important since the oxidizing substances comprised in the soluble product 27 may damage, if put in the reservoir 14, during the empty cycle, the parts of the machine wherein it is envisaged the sole passage of hot water under pressure.

Of course, obvious changes and/or variants of the invention are possible to the above disclosure in the dimensions, shapes, materials, components and connections and in the same manner in the details of the indicated construction and of the operating method without being out of the scope of the invention as defined in the following claims.

1. A KIT for a coffee capsule machine comprising, in cascade, a feeding water reservoir, an infusion module comprising an infusion chamber and a brewing group and set up to prepare brews with hot water under pressure, said KIT comprising
at least a soluble product set up to be inserted in a body of a capsule, said soluble product comprising oxidizing substances suitable to supply oxygen after the contact with water under pressure,
at least a cap comprising on a crown or edge thereof an adhesive sets up to seal said soluble product inside the body of the capsule, so as to, during use, inserting said capsule obtained with said KIT in said infusion chamber to carry out cleaning and hygiene operation of said infusion module and/or of said brewing group during at least an empty cycle of said machine.

2. The KIT according to claim 1 wherein said at least soluble a product comprises at least a tablet which slowly releases oxidizing substances after the contact with hot water under pressure.

3. The KIT according to claim 1 wherein said adhesive is edible.

4. The KIT according to claim 1, wherein said body is comprised in the KIT.

5. The KIT according to claim 1, wherein said cap is made of a material selected from the group consisting of natural aluminum, perforated polypropylene, and aluminum coupled with polypropylene.

6. A method for arranging and using a cleaning and hygiene KIT of a capsule machine comprising: a feeding water reservoir an infusion module and a brewing group, said machine being set up to prepare brews with hot water under pressure;
said method comprising
arranging a soluble product comprising oxidizing substances suitable to supply oxygen after the contact with hot water under pressure;
arranging a cap comprising an adhesive on a crown or edge thereof,
sealing said soluble product inside a body of capsule through said cap,
activating at least an empty cycle of the machine, and
carrying out in an automatic way a cleaning an hygiene operation of the infusion module and/or of the brewing group of the machine.

7. The method according to claim 6, wherein said sealing phase of the soluble product inside the body of the capsule comprises the steps of:
removing the cap from a support material,
fixing the cap to the body through an adhesive.

8. The method according to claim 6 wherein said phase of carrying out in an automatic way a cleaning and hygiene operation of the infusion module and/or the brewing group of the machine comprises the steps of:
slowly releasing oxidizing substances after the contact of the soluble product with hot water under pressure.

9. The method according claim 6 wherein said phase of arranging a soluble product comprises the steps of
arranging said soluble product in the form of one or more soluble tablets which slowly release oxidizing substances after the contact with hot water under pressure.
